(19) United States
(12) Patent Application Publication
(10) Pub. No.: US 2025/0083149 A1
(43) Pub. Date: Mar. 13, 2025

(54) NUCLEIC ACID AMPLIFICATION SYSTEM AND METHOD OF NUCLEIC ACID AMPLIFICATION

(71) Applicant: Samsung Electronics Co., Ltd., Suwon-si (KR)

(72) Inventors: Shailabh Kumar, Pasadena, CA (US); Vinayak Narasimhan, Altadena, CA (US); Hyuck Choo, Yongin-si (KR); Radwanul Hasan Siddique, Monrovia, CA (US); Yibing Michelle Wang, Temple City, CA (US)

(21) Appl. No.: 18/491,602

(22) Filed: Oct. 20, 2023

Related U.S. Application Data
(60) Provisional application No. 63/537,132, filed on Sep. 7, 2023.

(51) Int. Cl. B01L 7/00

(52) U.S. Cl. CPC B01L 7/52; B01L 2200/14; B01L 2300/18

(57) ABSTRACT

A nucleic acid amplification system includes a single use chemical heater, a fluidic consumable on the single use chemical heater that is configured to contain a test sample including target nucleic acids, a multi-use heater configured to heat the single use chemical heater and/or the fluidic consumable, a temperature sensor configured to measure a temperature of the test sample in the fluidic consumable, a computer device including a processor, a non-volatile memory device, and a controller that is configured to control the multi-use heater, and a detection system configured to detect the target nucleic acids.

### CROSS-REFERENCE TO RELATED APPLICATION(S)

The present application claims priority to and the benefit of U.S. Provisional Application No. 63/537,132 filed Sep. 7, 2023, the entire content of which is incorporated herein by reference.

### BACKGROUND

### 1. Field

The present disclosure relates to systems and methods of nucleic acid amplification.

### 2. Description of the Related Art

Nucleic acid amplification tests (NAATs) are the gold standard for the detection of several pathogens and diseases. NAAT tests are enzyme-based reactions which can multiply a single copy of target DNA or RNA into several millions of copies, thereby enabling straightforward detection with very high sensitivity. NAAT tests can be 1,000 times more sensitive than antigen-based rapid tests.

Various nucleic acid (NA) amplification strategies exist in the market, including but not limited to, polymerase chain reaction (PCR), loop-mediated isothermal amplification (LAMP), nucleic acid sequence based amplification (NASBA), strand displacement amplification (SDA), multiple displacement amplification (MDA), rolling circle amplification (RCA), ligase chain reaction (LCR), helicase dependent amplification (HDA), ramification amplification method (RAM), recombinase polymerase reaction (RPA), and whole genome amplification (WGA). Amplification is performed by enzymes requiring cyclical thermocycling or isothermal operation and monitoring of the temperature.

Typical NA amplification tests require bulky, benchtop instruments plugged into an outlet. These typical NA amplification tests, which utilize dedicated power-intensive instrumentation, typically consume between 150 Watts (W) and 470 W, which is very high. Additionally, these typical NA amplification tests can require approximately 1 hour to perform due to the large reaction volumes, reaction conditions and chemistry, and slow thermal ramp rates on traditional thermocyclers. These long test times make typical NA amplification tests inconvenient as point of care options.

### SUMMARY

The present disclosure includes various embodiments of a nucleic acid amplification system. In one embodiment, the nucleic acid amplification system includes a single use chemical heater, a fluidic consumable on the single use chemical heater that is configured to contain a test sample including target nucleic acids, a multi-use heater configured to heat the single use chemical heater and/or the fluidic consumable, a temperature sensor configured to measure a temperature of the test sample in the fluidic consumable, a computer device including a processor, a non-volatile memory device, and a controller, wherein the non-volatile memory device includes instructions which, when executed by the processor, cause the controller to control the multi-use heater, and a detection system configured to detect the target nucleic acids.

The controller may be a proportional (P) controller, a proportional integral (PI) controller, a proportional-integral-derivative (PID) controller, or a bang-bang controller.

The single use chemical heater may include iron powder in a porous bag. The iron powder is configured to oxidize and generate heat in an exothermic reaction in the presence of moisture and air.

The chemical heater may include activated charcoal, sodium chloride, and/or vermiculite in the porous bag.

The multi-use heater may be a resistive heater, an inductive heater, and/or a photothermal heater.

The nucleic acid amplification system may also include a cooling device.

The fluidic consumable may be a chip plate, a microcentrifuge tube, a well plate, or a microfluidic channel.

The nucleic acid amplification system may include a test sample containing a target nucleic acid in the fluidic consumable and an additive mixture mixed with the test sample that is configured to reduce detection time of the target nucleic acid.

The additive mixture may include a serum albumin protein, a biocompatible molecular crowding agent, a chaotrope and denaturant, or a detergent.

The serum albumin protein may include bovine serum albumin (BSA). The biocompatible molecular crowding agent may include polyethylene glycol (PEG). The chaotrope and denaturant may include guanidine hydrochloride (GuCl). The detergent may include Triton-X 100.

The additive mixture may include PEG in a range from approximately 0.1 mg/ml to approximately 10 mg/mL, BSA in a range from approximately 0.1 mg/mL to approximately 10 mg/mL, GuCl in a range from approximately 10 mM to approximately 60 mM, and Triton-X in a range from approximately 0.01% to approximately 1%.

The PEG may a molecular weight of 1,000 g/mol, 2,000 g/mol, or 10,000 g/mol.

The detection system may include a light source and a camera, a spectrometer, or device outputting an electrochemical readout.

The present disclosure also relates to various embodiments of a method of nucleic acid amplification. In one embodiment, the method includes mixing a test sample with an additive mixture in a fluidic consumable, heating the test sample with a hybrid heater comprising a multi-use electric heater and a disposable chemical heater, and detecting the presence of a target nucleic acid in the test sample.

The heating may be an isothermal heating operation.

The heating may be a thermocycling heating operation.

The additive mixture may include a serum albumin protein, a biocompatible molecular crowding agent, a chaotrope and denaturant, and a detergent.

The serum albumin protein may include bovine serum albumin (BSA). The biocompatible molecular crowding agent may include polyethylene glycol (PEG). The chaotrope and denaturant may include guanidine hydrochloride (GuCl). The detergent may include Triton-X 100.

The additive mixture may include PEG in a range from approximately 0.1 mg/mL to approximately 10 mg/mL, BSA in a range from approximately 0.1 mg/mL to approximately 10 mg/mL, GuCl in a range from approximately 10 mM to approximately 60 mM, and Triton-X in a range from approximately 0.01% to approximately 1%.

This summary is provided to introduce a selection of concepts that are further described below in the detailed description. This summary is not intended to identify key or essential features of the claimed subject matter, nor is it intended to be used in limiting the scope of the claimed subject matter. One or more of the described features and/or tasks may be combined with one or more other described features and/or tasks to provide a workable system and/or a workable method.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and advantages of embodiments of the present disclosure will be better understood by reference to the following detailed description when considered in conjunction with the accompanying figures. In the figures, like reference numerals are used throughout the figures to reference like features and components. The figures are not necessarily drawn to scale.

FIG. 1 is a schematic diagram of a nucleic acid amplification system according to one embodiment of the present disclosure;

FIG. 2A is a graph depicting the setpoint temperature profile of a hybrid heater including a chemical heater and an electric heater operating in an isothermal heating mode according to one embodiment of the present disclosure;

FIG. 2B is a chart depicting the energy savings as a function of time utilizing the hybrid heater according to one embodiment of the present disclosure compared to utilizing an electric heater only;

FIG. 3A is a graph depicting the temperature variation of the chemical heater over time according to one embodiment of the present disclosure;

FIG. 3B is a graph depicting the spatial variation of the heat generated by the chemical heater according to one embodiment of the present disclosure;

FIG. 3C is a graph comparing the temperature profile and the energy consumption of the hybrid heater according to one embodiment of the present disclosure to an electric heater only;

FIGS. 4A-4B are graphs depicting the setpoint temperature profile of a hybrid heater including a chemical heater and an electric heater operating in a thermocycling heating mode according to one embodiment of the present disclosure;

FIG. 5 is a graph comparing the reaction time to detect Lambda DNA utilizing an additive mixture according to one embodiment of the present disclosure, a related art additive mixture, and without an additive mixture;

FIG. 6 depicts photographs showing the detection of lambda DNA in a chip plate with three different reaction mixes;

FIG. 7 depicts photographs showing the detection of lambda DNA in microcentrifuge tubes with three different reaction mixes;

FIG. 8 is a graph comparing the reaction time to detect SARS-CoV2 utilizing an additive mixture according to one embodiment of the present disclosure and three different related art additive mixtures; and

FIG. 9 depicts photographs showing the detection of SARS CoV-2 in a chip plate with four different buffer materials.

### DETAILED DESCRIPTION

The present disclosure relates to various embodiments of a nucleic acid amplification system configured to detect the presence of target nucleic acids (e.g., DNA or RNA) in a test sample. The nucleic acid amplification system according to one embodiment of the present disclosure includes both a single use chemical heater (e.g., a disposable or consumable chemical heater) and a multi-use electric heater. The combination of the chemical heater and the electric heater is configured to reduce power consumption and reduce the time to detection of the target nucleic acids. Additionally, the nucleic acid amplification system according to one embodiment of the present disclosure includes an additive, such as a mixture of bovine serum albumin (BSA), polyethylene glycol (PEG), guanidine hydrochloride (GuCl), and Triton-X 100, which is configured to reduce the time to detection of the target nucleic acids. In this manner, the systems of the present disclosure are faster, more efficient, and more convenient than related art nucleic acid amplification systems.

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

For the purposes of this disclosure, expressions such as “at least one of,” when preceding a list of elements, modify the entire list of elements and do not modify the individual elements of the list. For example, “at least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, YZ, and ZZ, or any variation thereof. Similarly, the expression such as “at least one of A and B” may include A, B, or A and B. As used herein, “or” generally means “and/or,” and the term “and/or” includes any and all combinations of one or more of the associated listed items. For example, the expression such as “A and/or B” may include A, B, or A and B.

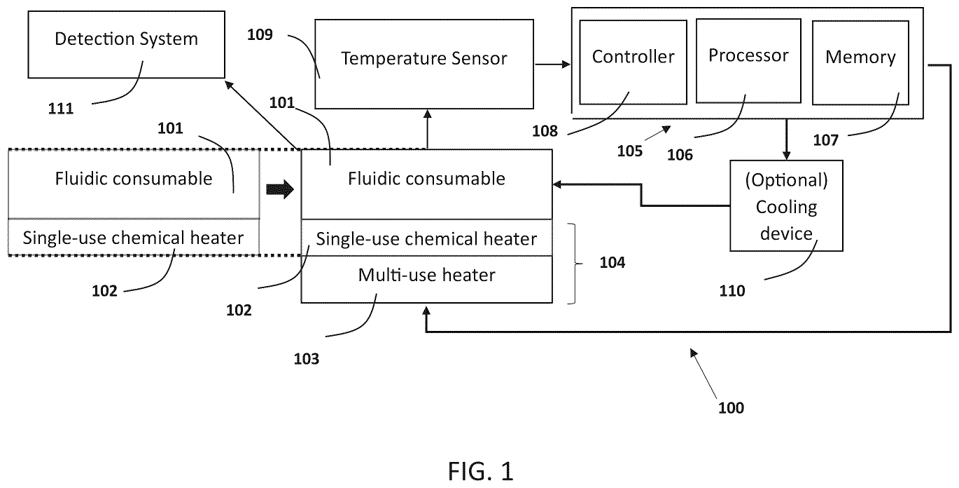

FIG. 1 is a schematic block diagram of a nucleic acid amplification system 100 configured to detect the presence of target nucleic acids (e.g., DNA or RNA) in a test sample according to one embodiment of the present disclosure. In the illustrated embodiment, the system 100 includes a fluidic consumable 101, such as a chip plate, a microcentrifuge tube, a microfluidic channel, a cartridge, or a well plate (e.g., a 96-well plate), configured to contain the test sample and an additive mixture configured to accelerate the process of amplifying the target nucleic acids in the test sample.

In the illustrated embodiment, the system 100 also includes a disposable chemical heater 102 (e.g., a single use chemical heater) configured to heat the test sample and the additive mixture in the fluidic consumable 101. In one or more embodiments, the fluidic consumable 101 may be on (e.g., directly on) the disposable chemical heater 102. In one or more embodiments, the single use chemical heater 102 may include a porous satchel or bag containing iron powder, which is configured to oxidize and generate heat in an exothermic reaction in the presence of moisture and oxygen in the surrounding environment. In one or more embodiments, the disposable chemical heater 102 may include activated charcoal in the porous bag (e.g., activated charcoal mixed with the iron powder) that is configured to contain the moisture that it utilized in the oxidation of the iron powder. In one or more embodiments, the disposable chemical heater 102 may include sodium chloride in the porous bag (e.g., sodium chloride mixed with the iron powder and, optionally, the activated charcoal) that is configured to accelerate the oxidation of the iron powder. In one or more embodiments, the disposable chemical heater 102 may include vermiculite in the porous bag (e.g., vermiculite mixed with the iron powder and, optionally, the activated charcoal and/or the sodium chloride) that is configured to provide thermal insulation for the heat generated by the oxidation of the iron powder.

In the illustrated embodiment, the system 100 also includes a multi-use electric heater 103. The multi-use electric heater 103 is configured to support the disposable chemical heater 102 and the fluidic consumable 101. In use, the disposable chemical heater 102, and the fluidic consumable 101 thereon, may be placed on (e.g., directly on) an upper surface of the multi-use electric heater 103. The multi-use electric heater 103 may be any suitable type or kind of electric heater, such as a resistive heater an inductive heater, or a photothermal heater. The use of the disposable chemical heater 102 is configured to reduce the power consumption of the multi-use electric heater 103. In an inductive heater, heat is generated by passing a current through a resistive element, and then that heat is transferred to the disposable chemical heater 102 and the fluidic consumable 101. The inductive heater uses an electromagnetic coil with a high-frequency AC current to generate eddy currents within ferromagnetic materials, such as iron. In this manner, the inductive heater is configured to heat up iron powder in the disposable chemical heater 102. In one or more embodiments, the heating element that is heated by the inductive heater may be separate from the disposable chemical heater 102 (e.g., the inductive heater does not need to rely on heating the iron powder in the disposable chemical heater 102 because there may be a inductive heating element that is separate from the iron powder in the disposable chemical heater 102). The photothermal heater is configured to convert electrical power to light, and the illumination of the fluidic consumable 101 by this light is configured to heat the fluidic consumable 101. Together, the disposable chemical heater 102 and the multi-use electric heater 103 form a hybrid heater 104.

In the illustrated embodiment, the system 100 also includes a computer system 105 coupled to the multi-use electric heater 103. The computer system 105 includes a processor 106, a non-volatile memory device 107 connected to the processor 106, and a controller 108 connected to the processor 106. The non-volatile memory device 107 includes computer readable instructions which, when executed by the processor 106, cause the controller 108 to control the temperature of the multi-use electric heater 103. The controller 108 may be any suitable type or kind of controller, such as a proportional (P) controller, a proportional integral (PI) controller, a proportional-integral-derivative (PID) controller, or a bang-bang controller. The instructions stored in the non-volatile memory device 107 may be configured to cause the controller 108 to heat the multi-use electric heater 103 in a thermocycling heating operation and/or an isothermal heating operation.

As used herein, the term “processor” includes any combination of a circuit, hardware, firmware, memory, and software, employed to process data or digital signals. The hardware of a controller may include, for example, a microcontroller, application specific integrated circuits (ASICs), general purpose or special purpose central processors (CPUs), digital signal processors (DSPs), graphics processors (GPUs), and/or programmable logic devices such as field programmable gate arrays (FPGAs). In a processor, as utilized herein, each function is performed either by hardware configured, i.e., hard-wired, to perform that function, or by more general purpose hardware, such as a CPU, configured to execute instructions stored in a non-transitory storage medium or memory. A processor may contain two or more processors, for example, a processor may include two processors, an FPGA and a CPU, interconnected on a PCB.

In the illustrated embodiment, the system 100 also includes a temperature sensor 109 configured to measure or determine the temperature of the test sample and the additive mixture in the fluidic consumable 101. The temperature sensor 109 may be either a contact type temperature sensor (e.g., a thermocouple) or a non-contact type temperature sensor (e.g., an infrared (IR) sensor).

In one or more embodiments, the system 100 includes a cooling device 110 configured to cool the test sample and the additive mixture in the fluidic consumable 101. In one or more embodiments, the system 100 may not include the cooling device 110.

Additionally, in the illustrated embodiment, the system 100 includes a detection system 111 configured to detect the presence of the target nucleic acids in the test sample after the system 100 has been utilized to amplify the target nucleic acids in the test sample. The detection system 111 may include a light source and a camera, a spectrometer, or a device configured to output an electrochemical readout.

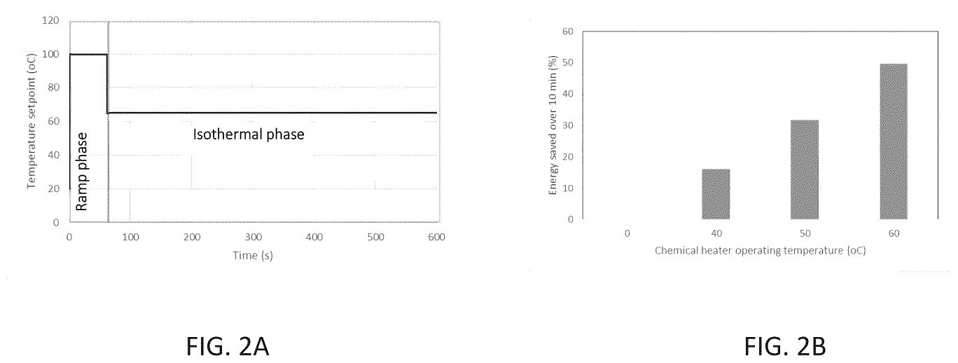

FIG. 2A is a graph depicting the setpoint temperature profile of the hybrid heater 104 (including the disposable chemical heater 102 and the multi-use electric heater 103) operating in an isothermal heating mode. In the illustrated embodiment, the temperature ramped up to approximately 100° C. over approximately 60 seconds or less (“Ramp Phase”), and then the temperature was reduced to a constant temperature of approximately 65° C. for the remainder of the heating process (“Isothermal Phase”). In one or more embodiments, the hybrid heater 103 may not heat above the isothermal temperature (e.g., the hybrid heater 104 may heat at a constant temperature, such as approximately 63° C., over the entire (or substantially the entire) temperature profile). FIG. 2B and Table 1 below shows the energy consumption of the multi-use electric heater 103 as a function of the heat generated by the disposable chemical heater 102. As illustrated in Table 1 and FIG. 2B, the energy consumption of the multi-use electric heater 103 decreases with increasing heat generated by the disposable chemical heater 102. In an embodiment in which the hybrid heater 104 was utilized to heat the test sample to approximately 65° C. in an isothermal heating mode, the energy consumption of the multi-use electric heater 103 that was saved, after approximately 10 minutes, was approximately 16.2% when the disposable chemical heater 102 generated heat at approximately 40° C., approximately 31.8% when the disposable chemical heater 102 generated heat at approximately 50° C., and approximately 49.7% when the disposable chemical heater 102 generated heat at approximately 60° C. That is, the heat generated by the disposable chemical heater 102 (due to the exothermic oxidation of the iron powder) reduces the energy consumption of the multi-use electric heater 103 that is required to heat the test sample to a particular temperature compared to using the multi-use electric heater 103 alone to heat the test sample in the fluidic consumable 101.

TABLE 1

| | Electrical heater energy | |
|---|---|---|
| Chemical heater (° C.) | consumption (kWh) | Energy saved (%) |
| 0 | 0.000132596 | 0 |
| 40 | 0.000111146 | 16.17697891 |
| 50 | 9.04979E−05 | 31.74904943 |
| 60 | 6.66875E−05 | 49.70618735 |

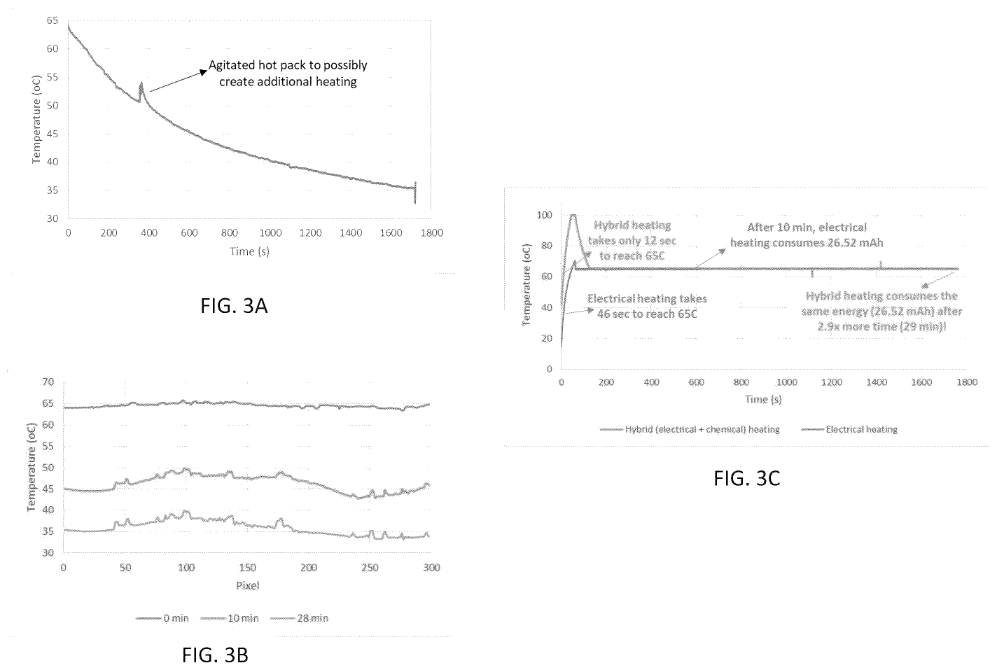

FIG. 3A is a graph depicting the temperature variation of the disposable chemical heater as a function of time. As illustrated in FIG. 3A, the disposable chemical heater 102 generated heat at approximately 65° C. nearly instantaneously, and then the heat generated by the disposable chemical heater 102 decreased to approximately 35° C. after approximately 1,700 seconds. Additionally, as illustrated in FIG. 3A, the disposable chemical heater 102 was agitated after approximately 350 seconds, which caused the disposable chemical heater 102 to increase its heat output from approximately 51° C. to approximately 54° C.

FIG. 3B depicts the spatial variation of the heat generated by the disposable chemical heater 102 initially (i.e., at 0 min), after approximately 10 minutes, and after approximately 28 minutes. As illustrated in FIG. 3B, initially (i.e., at 0 min), the disposable chemical heater 102 generates heat at approximately 65° C. substantially uniformly across the disposable chemical heater 102. After approximately 10 minutes, the heat generated by the disposable chemical heater 102 varied between a minimum temperature of approximately 43° C. and a maximum temperature of approximately 50° C. across the surface of the disposable chemical heater 102. After approximately 28 minutes, the heat generated by the disposable chemical heater 102 varied between a minimum temperature of approximately 28° C. and a maximum temperature of approximately 40° C. across the surface of the disposable chemical heater 102.

FIG. 3C is a graph comparing the temperature profile and the energy consumption of the hybrid heater 104 to an electric heater only when operated in an isothermal heating mode. As illustrated in FIG. 3C, the hybrid heater 104 took only approximately 12 seconds to reach approximately 65° C., whereas the electric heater alone took approximately 46 seconds to reach approximately 65° C. Thus, the hybrid heater 104 reached approximately 65° C. approximately 4 times faster than the electric heater alone. Accordingly, in one embodiment, the hybrid heater 104 was approximately 74% faster at achieving a temperature of approximately 65° C. than the electric heater alone.

Additionally, as illustrated in FIG. 3C and Table 2 below, the hybrid heater 104 consumed only approximately 11.12 mAh after approximately 10 minutes, whereas the electric heater alone consumed approximately 26.52 mAh after approximately 10 minutes. Thus, the hybrid heater 104 consumed less than half of the energy that the electric heater alone consumed. Accordingly, in one or more embodiments, the hybrid heater 104 is approximately 58% more energy efficient after approximately 10 minutes than the electric heater alone.

Moreover, it took approximately 29 minutes for the hybrid heater 104 to consume the same amount of energy (26.52 mAh) that the electric heater alone consumed after only approximately 10 minutes. Thus, it took the hybrid heater 104 approximately 2.9 times longer to consume the same amount of energy as the electric heater alone. Accordingly, the hybrid heater 104 reaches the target temperature faster and consumes less energy than the electric heater alone in reaching the target temperature.

TABLE 2

| | Heater time ON (s) | | Energy consumed (mAh) | | Time to |
|---|---|---|---|---|---|
| | After | After | After | After | 65° C. |
| Heating | 10 min | 30 min | 10 min | 30 min | (sec) |
| Elec- | 190.938 | — | 26.51916667 | — | 46 |
| trical | | | | | |
| Hybrid | 80.058 | 194.799 | 11.11916667 | 27.05541667 | 12 |

| | | |
|---|---|---|
| Savings by hybrid heating (%) | 58.07120636 | 73.91304348 |

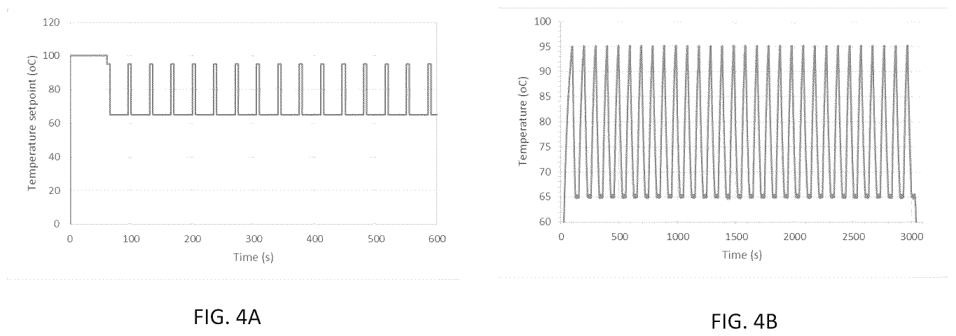

FIGS. 4A-4B are graphs depicting the setpoint temperature profile of the hybrid heater 104 (which includes the disposable chemical heater 102 and the multi-use electric heater 103) operating in a thermocycling heating mode. As shown in FIGS. 4A-4B, after an initial ramp phase in which the hybrid heater 104 generated heat at approximately 100° C. for approximately 60 seconds, the hybrid heater 104 was operated for 30 cycles in which each cycle included generating heat at approximately 95° C. for approximately 5 seconds and generating heat at approximately 64° C. for approximately 30 seconds. In one or more embodiments, the multi-use electrical heater 103 of the hybrid heater 104 was controlled in the thermocycling heating mode utilizing the bang-bang controller 108, and the multi-use electric heater 103 was drawing approximately 500 mA.

As illustrated in Table 3 below, the multi-use electrical heater 103 consumed approximately 0.00046 kWh when the disposable chemical heater 102 was not outputting any heat, and the multi-use electrical heater 103 consumed approximately 0.00040 kWh when the disposable chemical heater 102 was outputting heat at approximately 50° C. Thus, the hybrid heater 104 saved approximately 12.8% in energy consumption compared to the electric heater alone.

TABLE 3

| | Electrical heater energy | |
|---|---|---|
| Chemical heater (° C.) | consumption (kWh) | Energy saved (%) |
| 0 | 0.000461055 | 0 |
| 50 | 0.000401844 | 12.84262763 |

In one or more embodiments, the additive mixture in the fluidic consumable 101 may be a combination of a serum albumin protein (e.g., bovine serum albumin (BSA)), a biocompatible molecular crowding agent (e.g., polyethylene glycol (PEG)), a chaotrope and denaturant (e.g., guanidine hydrochloride (GuCl)), and a detergent (e.g., Triton-X 100). In one or more embodiments, the additive mixture may include PEG in a range from approximately 0.1 mg/mL to approximately 10 mg/mL, BSA in a range from approximately 0.1 mg/mL to approximately 10 mg/mL, GuCl in a range from approximately 10 mM to approximately 60 mM, and Triton-X in a range from approximately 0.01% to approximately 1%. The PEG may have a molecular weight of 1,000 g/mol, 2,000 g/mol, or 10,000 g/mol.

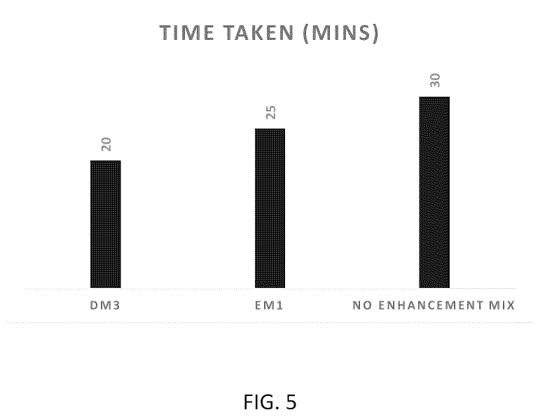

FIG. 5 is a graph comparing the reaction time to detect Lambda DNA at 10⁴ cps/μL utilizing an additive mixture according to one embodiment of the present disclosure containing GuCl, Triton-X 100, BSA, and PEG (labeled “DM3” in FIG. 5), a related art additive mixture including GuCl and Triton-X 100 (labeled “EM1” in FIG. 5), and without an additive mixture (labeled “No Enhancement Mix” in FIG. 5). As illustrated in FIG. 5, the Lambda DNA was detected in approximately 20 minutes utilizing the additive mixture GuCl, Triton-X 100, BSA, and PEG (“DM3”), whereas the Lambda DNA was detected in approximately 25 minutes utilizing an additive mixture containing just GuCl and Triton-X 100 (“EM1”) and the Lambda DNA was detected in approximately 30 minutes without utilizing an additive mixture (“No Enhancement Mix”).

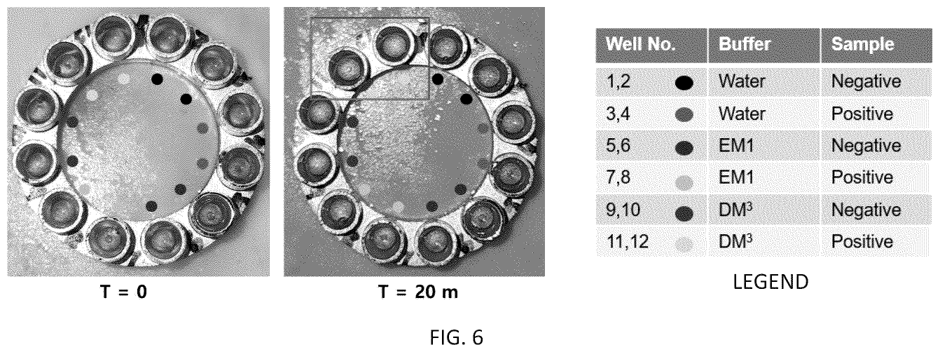

FIG. 6 depicts photographs of a well plate (formed of aluminum-oxide and aluminum-coated plastic) containing positive and negative samples of lambda DNA at 10⁴ cps/μL. The well plate also contained three different reaction mixtures mixed with the test samples: (i) water; (ii) EM1 (i.e., GuCl and Triton-X 100); and (iii) DM3 (i.e., GuCl, Triton-X 100, BSA, and PEG). FIG. 6 shows the well plate initially (“T=0”) and after 20 minutes (“T=20 m”). As illustrated in FIG. 6, the samples containing DM3 produced accurate test results (shown by color change) approximately 3 to 5 minutes faster than the samples containing EM1 and approximately 7 to 10 minutes faster than the samples containing water.

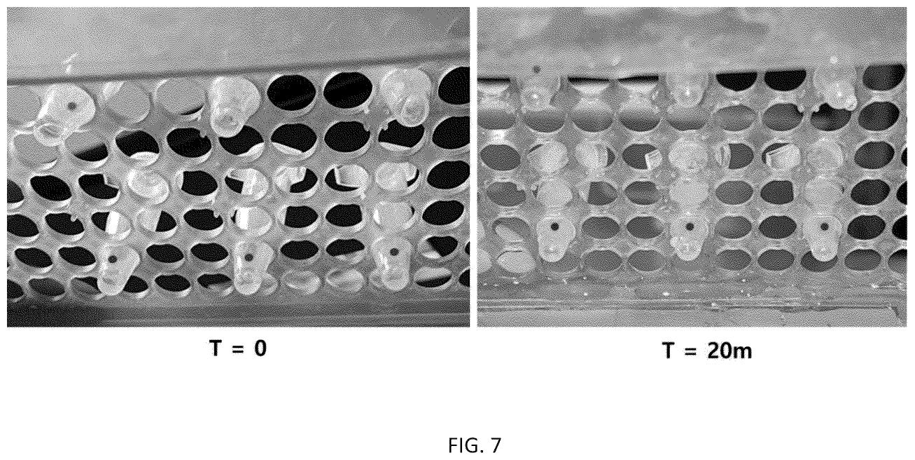

FIG. 7 depicts photographs of microcentrifuge tubes containing positive and negative samples of lambda DNA at 10⁴ cps/μL. The microcentrifuge tubes also contained three different reaction mixtures: (i) water; (ii) EM1 (i.e., GuCl and Triton-X 100); and (iii) DM3 (i.e., GuCl, Triton-X 100, BSA, and PEG) initially (“T=0”) and after 20 minutes (“T=20 m”). The samples containing DM3 produced accurate test results (shown by color change) faster than the samples containing EM1 and the samples containing water.

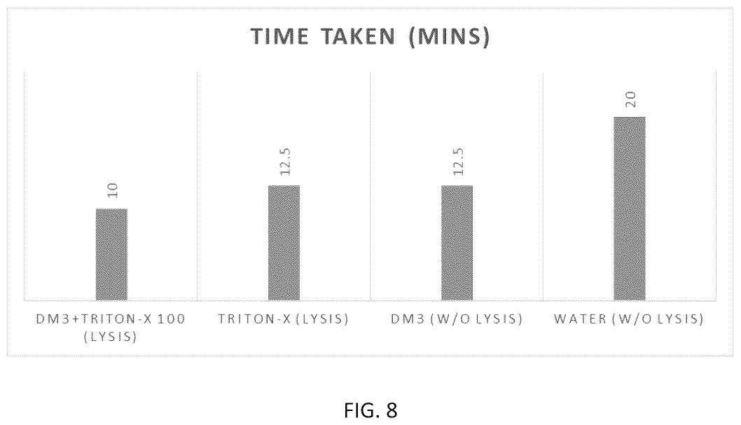

FIG. 8 is a graph comparing the reaction time to detect SARS CoV-2 at 10⁴ cps/μL utilizing an additive mixture according to one embodiment of the present disclosure containing GuCl, Triton-X 100, BSA, and PEG and utilizing lysis (labeled “DM3+Triton-X 100 (Lysis)” in FIG. 8), a related art additive mixture including Triton-X 100 and utilizing lysis (labeled “Triton-X (Lysis)” in FIG. 8), an additive mixture according to one embodiment of the present disclosure containing GuCl, Triton-X 100, BSA, and PEG and without utilizing lysis (labeled “DM3 (w/o Lysis)” in FIG. 8), and utilizing water without lysis (labeled “Water (w/o lysis)” in FIG. 8). As illustrated in FIG. 8, the SARS CoV-2 was detected in approximately 10 minutes utilizing DM3 with lysis, whereas the SARS CoV-2 was detected in approximately 12.5 minutes utilizing Triton-X with lysis or DM3 without lysis, and the SARS CoV-2 was detected in approximately 20 utilizing water without lysis. Accordingly, utilizing DM3 (i.e., an additive mixture containing GuCl, Triton-X 100, BSA, and PEG) improved detection time by more than 7 minutes compared to samples without lysis.

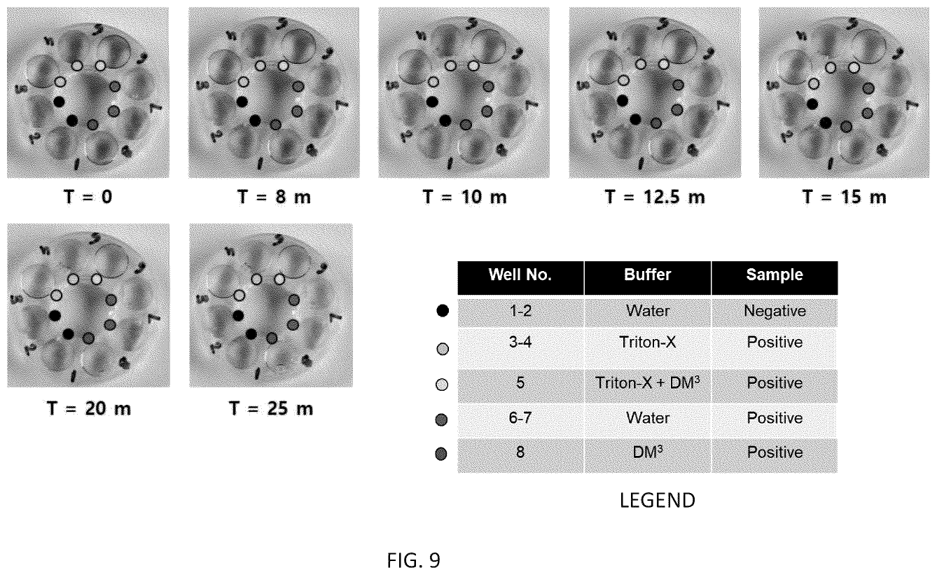

FIG. 9 depicts photographs of a well plate (formed by 3D printing) containing positive and negative samples of SARS CoV-2 at 10⁴ cps/μL. The well plate also contained four different reaction mixtures mixed with the test samples: (i) water; (ii) Triton-X; (iii) Triton-X and DM3 (i.e., GuCl, Triton-X 100, BSA, and PEG); and (iv) DM3 (i.e., GuCl, Triton-X 100, BSA, and PEG). FIG. 9 shows the well plate initially (“T=0”), after 8 minutes (“T=8 m”). after 10 minutes (“T=10 m”), after 12.5 minutes (“T=12.5 m”), after 15 minutes (“T=15 m”), after 20 minutes (“T=20 m”), and after 25 minutes (“T=25 m”). As illustrated in FIG. 9, the samples containing DM3 showed the test results (shown by color change) in approximately 10 minutes, which is faster than the samples containing Triton-X and the samples containing water.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims.

What is claimed is:

1. A nucleic acid amplification system comprising:
a single use chemical heater;
a fluidic consumable on the single use chemical heater, the fluidic consumable being configured to contain a test sample including target nucleic acids;
a multi-use heater configured to heat the single use chemical heater and/or the fluidic consumable;
a temperature sensor configured to measure a temperature of the test sample in the fluidic consumable;
a computer device comprising a processor, a non-volatile memory device, and a controller, wherein the non-volatile memory device comprises instructions which, when executed by the processor, cause the controller to control the multi-use heater; and
a detection system configured to detect the target nucleic acids.

2. The nucleic acid amplification system of claim 1, wherein the controller is selected from the group of controllers consisting of a proportional (P) controller, a proportional integral (PI) controller, a proportional-integral-derivative (PID) controller, and a bang-bang controller.

3. The nucleic acid amplification system of claim 1, wherein the single use chemical heater comprises iron powder in a porous bag, wherein the iron powder is configured to oxidize and generate heat in an exothermic reaction in the presence of moisture and air.

4. The nucleic acid amplification system of claim 1, wherein the chemical heater further comprises activated charcoal, sodium chloride, and/or vermiculite in the porous bag.

5. The nucleic acid amplification system of claim 1, wherein the multi-use heater is selected from the group consisting of a resistive heater, an inductive heater, and a photothermal heater.

6. The nucleic acid amplification system of claim 1, further comprising a cooling device.

7. The nucleic acid amplification system of claim 1, wherein the fluidic consumable comprises a device selected from the group consisting of a chip plate, a microcentrifuge tube, a well plate, and a microfluidic channel.

8. The nucleic acid amplification system of claim 1, further comprising:
a test sample containing a target nucleic acid in the fluidic consumable; and
an additive mixture mixed with the test sample, wherein the additive mixture is configured to reduce detection time of the target nucleic acid.

9. The nucleic acid amplification system of claim 8, wherein the additive mixture comprises a serum albumin protein, a biocompatible molecular crowding agent, a chaotrope and denaturant, and a detergent.

10. The nucleic acid amplification system of claim 9, wherein:
the serum albumin protein comprises bovine serum albumin (BSA);
the biocompatible molecular crowding agent comprises polyethylene glycol (PEG);
the chaotrope and denaturant comprises guanidine hydrochloride (GuCl); and
the detergent comprises Triton-X 100.

11. The nucleic acid amplification system of claim 10, wherein the additive mixture comprises PEG in a range from approximately 0.1 mg/mL to approximately 10 mg/mL, BSA in a range from approximately 0.1 mg/mL to approximately 10 mg/mL, GuCl in a range from approximately 10 mM to approximately 60 mM, and Triton-X in a range from approximately 0.01% to approximately 1%.

12. The nucleic acid amplification system of claim 11, wherein the PEG has a molecular weight of 1,000 g/mol, 2,000 g/mol, or 10,000 g/mol.

13. The nucleic acid amplification system of claim 1, wherein the detection system comprises a light source and a camera, a spectrometer, or device outputting an electrochemical readout.

14. A method of nucleic acid amplification, the method comprising:
mixing a test sample with an additive mixture in a fluidic consumable;
heating the test sample with a hybrid heater comprising a multi-use electric heater and a disposable chemical heater; and
detecting the presence of a target nucleic acid in the test sample.

15. The method of claim 14, wherein the heating is an isothermal heating operation.

16. The method of claim 14, wherein the heating is a thermocycling heating operation.

17. The method of claim 14, wherein the additive mixture comprises a serum albumin protein, a biocompatible molecular crowding agent, a chaotrope and denaturant, and a detergent.

18. The method of claim 17, wherein:
the serum albumin protein comprises bovine serum albumin (BSA);
the biocompatible molecular crowding agent comprises polyethylene glycol (PEG);
the chaotrope and denaturant comprises guanidine hydrochloride (GuCl); and
the detergent comprises Triton-X 100.

19. The method of claim 18, wherein the additive mixture comprises PEG in a range from approximately 0.1 mg/mL to approximately 10 mg/mL, BSA in a range from approximately 0.1 mg/mL to approximately 10 mg/mL, GuCl in a range from approximately 10 mM to approximately 60 mM, and Triton-X in a range from approximately 0.01% to approximately 1%.
